(19) United States
(12) Patent Application Publication
(10) Pub. No.: US 2009/0271292 A1
(43) Pub. Date: Oct. 29, 2009

(54) SYSTEMS AND METHODS FOR EXCHANGING DIRECT RESPONSE MARKETING PHONE LEADS

(76) Inventors: Saurabh Khetrapal, Palo Alto, CA (US); Karandeep Sandhu, Mountain View, CA (US)

Correspondence Address: IPSG, P.C., P.O. BOX 700640, SAN JOSE, CA, 95170, US

(21) Appl. No.: 12/501,209

(22) Filed: Jul. 10, 2009

Related U.S. Application Data
(63) Continuation-in-part of application No. 11/242,214, filed on Sep. 30, 2005.
Application No. 11/242,214 is a continuation-in-part of application No. 11/021,838, filed on Dec. 24, 2004.
Application No. 11/021,838 is a continuation-in-part of application No. 10/853,977, filed on May 25, 2004.

(51) Int. Cl. G06Q 30/00; G06Q 50/00; H04M 3/42

(52) U.S. Cl. 705/26; 705/34; 379/216.01

(57) ABSTRACT

Systems and methods for managing a phone lead transaction between a lead seller and a lead buyer as part of a first transaction between said lead seller and a consumer. The method, for example, includes enabling a plurality of lead buyers to bid for phone leads from at least, one lead seller. When the lead seller conducts a transaction with a consumer, a prequalification question is displayed to an agent associated with the lead seller to allow the agent to ascertain whether the consumer qualifies. If the consumer qualifies, the consumer is connected to the lead buyer either immediately or at a later time. Methods are disclosed for tracking the phone lead transaction and performing back-end accounting for account settlement purposes.

### RELATED APPLICATIONS

This is a continuation-in-part of Ser. No. 11/242,214 filed Sep. 30, 2005, Ser. No. 11/021,838 filed Dec. 24, 2004, Ser. No. 10/853,977 filed May 25, 2004, and Ser. No. 11/382,626, filed May 10, 2006, all incorporated herein by reference.

### BACKGROUND

The invention relates in general to systems and methods for buying and selling sales leads. In particular, the invention relates to computer-implemented systems and techniques that allow a seller to improve revenue generation from the sale of their phone leads while providing temporally-relevant information to potential customers/callers to enable customers/callers to obtain high quality products/services from a different seller.

Marketing and advertising costs often represent a large percentage of operating costs for companies engaged in the sales of products and/or services (products/services). Corporate marketing strategists expend significant resources to determine how best to optimize marketing and advertising campaigns to target potential customers at the lowest cost. The potential customer information is often referred to sales leads and can include one or more sub-categories, for example, suspects which are defined generally as possible customers, and prospects which are defined generally as suspects who have indicated a heightened willingness to purchase the products/services.

One technique that marketing strategists employ is to develop an ideal customer profile and audience, and suitable means for communicating with the ideal audience, such as direct mail, telephone solicitations, advertising in trade publications, trade shows, or seminars. This is generally a costly exercise for most companies, especially in mature competitive markets. Companies typically monitor their cost per lead or cost per prospect as a key performance indicator (KPI) for their marketing campaign. As a practical matter, marketing is only effective when certain conditions are met, e.g., a prospect must have the ability, willingness, and readiness to buy before a direct sale can be consummated.

It turns out that many customers who are interested in specific product/services may also be interested in complementary products/services (i.e., additional products/services related to the products/services already purchased). A conventional example of cross-selling to such customer leads include the familiar United States Post Office's Mover Package, which contains advertisements targeting customers who are relocating. The underlying common event is the relocation. The mover package contains advertisement flyers from cable companies, satellite TV companies, DSL providers, satellite radio, cell phone companies, rental companies, storage companies, moving companies, real estate, mortgage brokers and so forth. These are complementary products/services to the service already utilized, i.e., the Post Office's Mover Package.

Other conventional examples of cross-selling include, for example, up-selling complementary products at the point of sale based on the current purchase or purchasing history of the customer. These companies include, for example, online bookstores or grocery store check-out counters and they tend to promote products/services of the same company. Companies have also extracted past leads from a company's existing customer database and then sells those leads to other companies. Other paradigms such as mining data from the internet to develop a predictive model for targeting potential customer leads also exist. These sales leads can then be sold to other companies to realize revenue for the company selling the leads.

However, there are disadvantages to all the above-mentioned approaches. From the perspective of the company buying the leads, for example, there is insufficient control over how sales leads are selected and/or little assurance of the quality of the leads and/or whether they wish to pay for particular leads, and how much for the leads. In the Post Office example, all complementary products/services companies bear the cost of printing and distributing the advertisements although some movers/customers clearly cannot take advantage of certain products/services advertised (e.g., a mover moving out of the country would not be interested in the purchase of a new cable-vision package). Thus, from the perspective of the complementary products/services sellers who could not take advantage of certain movers leads, the printing/distributing/advertising costs attributed to such movers/customers are essentially wasted.

From the perspective of the company that already consummated the transaction, revenue is not maximized from the information available through the consummated transaction. As mentioned earlier, certain leads are more likely to produce a sale than others. However, there exist no mechanisms for efficiently allowing a company to qualify a hot prospect from a lukewarm prospect on behalf of a particular complementary products/services provider and to obtain more revenue from a hot prospect versus a lukewarm prospect.

Further, there is a risk associated with referral. A good customer who suffered through a bad experience with a complementary products/services provider may associate the experience with the referring company, and may resent the fact that she has suffered because of “bad information” provided by the referring company. Yet current lead referral or lead utilization paradigms do not furnish sufficient information to the referring company to enable to the referring company to make a decision regarding whether to refer a customer to a particular company that offers a complementary product/service.

Advertising is expensive and forms the mainstay for most companies' customer acquisition strategy. This is especially true for direct marketers that use a call center to close sales. Direct marketers typically spend their marketing budget on various advertising media—TV, radio, print, direct mail, and online advertising—to drive customer calls to its sales center. Driving qualified phone leads that deliver higher sales conversion is both challenging and very expensive. And in today's competitive global economy, companies are clamoring to leverage all facets of their business to stay successful. So, delivering a high return on investment on advertising budgets remains a top priority for companies.

The invention disclosed herein aims at solving these and other problems associated with prior art techniques of exchanging sales leads.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrate a server environment employed to implement the sales leads cross-selling service in accordance with an embodiment of the present invention.

FIG. 2 shows, in accordance with an embodiment, various components of the sales leads cross-selling system.

FIG. 3 shows, in accordance with an embodiment of the present invention, an example process flow for implementing sales lead cross-selling.

### DETAILED DESCRIPTION OF VARIOUS EMBODIMENTS

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described herein below, including methods and techniques. It should be kept in mind that the invention might also cover articles of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out tasks pertaining to embodiments of the invention. Examples of such apparatus include a general-purpose computer and/or a dedicated computing device when appropriately programmed and may include a combination of a computer/computing device and dedicated/programmable circuits adapted for the various tasks pertaining to embodiments of the invention.

For ease of reference, the company that already completed (or initiated, or partially completed) the sale of a product/service with a customer is referred to herein as the lead seller (LS). The LS may be able to generate valuable sale leads even if the transaction with the customer is not completely consummated/completed since the information regarding a customer's buying intention may already furnish valuable information to other sellers. For example, a customer's detailed inquiry regarding the technical abilities of a high definition television set would likely indicate a likelihood to buy, at some time, complementary products such as movie discs or services such as movie downloads. As another example, the fact that a customer is interacting in some manner with a particular lead seller in itself may mean that this particular customer is, from statistics or past experience, one likely to purchase another particular type of product or service. Thus, the term “transaction” or “transacted” is employed herein to associate a consumer or buyer with a particular product or service even if, for example, the customer is only at the exploratory stage or even if the sale is not completely consummated. This transaction, or the transacted goods/service, produces customer data, which may be subsequently transformed into leads and sold to generate additional revenue for the lead seller even if, as mentioned, the lead seller has not completed the sale to the customer.

The term “customer” is employed herein to include the consumer of the goods or services offered by either the lead selling company (also lead seller) or the lead buying company (also lead buyer). A company that wishes to offer the complementary goods/services is referred to herein as the prospective lead buyer (PLB). A prospective lead buyer who actually purchased or under contract to purchase a sales lead is referred to herein as the actual lead buyer (ALB). For example, if a lead seller enters into a contract with a prospective lead buyer to refer an offering of the prospective lead buyer to the customer or to provide customer's information as sales leads to the prospective lead buyer, the prospective lead buyer is obligated to pay for the referral and becomes an actual lead buyer. The offering by the actual lead buyer that is presented to the customer is referred to herein as an approved offering. A product/service may be judged by a prospective lead buyer as complementary to the prospective lead buyer's product/service based on any criteria established by the prospective lead buyer, including without limitation technological or lifestyle compatibility, geographical area compatibility, convenience enhancement for the purchased product/service, etc.

In embodiments of the invention, companies subscribe to the sales leads system to sell and buy sales leads. Lead sellers provide attribute data pertaining to themselves and their offerings. For example, an automobile dealership may provide attribute data pertaining to its location, the types of cars it sells, the types of services it offers. A company can be a lead seller for some offerings and a potential/actual lead buyer for other offerings. The attribute data pertaining to companies/offerings are then stored in a database.

A potential lead buyer then reviews the attribute data to determine whether an offering provided by a lead seller is complementary to the offerings provided by that potential lead buyer or whether customers of the lead sellers fit the profile of those likely to purchase goods or services from the potential lead buyer. Thus it is not always required that the goods/services of the potential lead buyer be complementary to the goods/services of the lead seller. Note that although the offerings provided by a potential lead buyer in an embodiment, the review may be performed using any data presentation arrangement that allows a person or software to view and/or filter and/or search through a database or a listing. In a typical situation, multiple lead buyers would be interested in obtaining sales leads due to the occurrence of a transaction between a lead seller and a customer with respect to an offering by the lead seller. For example, there may be multiple aftermarket high performance stereo dealers and installers interested in knowing the identity of a customer who just purchased a luxury performance sedan.

In an embodiment, these aftermarket high performance stereo dealers bid for the sales lead by submitting their bids to the lead seller. The bids may be based on a bulk purchase of sales leads (e.g., price per X numbers of sales leads per given amount of time) or may be based on individual characteristics of the customer individual transaction. In other words, the bids can be for a block of future sale leads, or for each sale leads as the transaction data becomes available.

If the bids are based on bulk purchase, the contract for the sales leads may be entered into before the customer transactions. If the bids are based on characteristics of individual transactions, the contract creates payment obligations when the transaction attribute data meets certain conditions established by the winning bidder (e.g., the type of car, the demographics of the customer, and/or whether the customer answers certain questions satisfactorily, etc.). The bids may be manually generated by the prospective lead buyers and submitted or may be computer-generated based on pre-defined criteria established by the prospective lead buyers.

In an embodiment, once the prospective lead buyer bids for and wins, the prospective lead buyer is obligated to pay for the leads delivered. In an embodiment, the prospective lead buyer is only obligated to pay for leads that satisfy certain additional predefined criteria, in addition to the complementary determination made by the prospective lead buyer. Alternatively or additionally, the prospective lead buyer is only obligated to pay for all sales leads that they bidded for and won but is also obligated to pay a premium for leads that satisfy certain additional predefined criteria.

In an embodiment, the prospective lead buyer is given an opportunity to qualify the sales lead to determine whether the sales lead should be purchased and/or how much the sales lead is worth. In the automobile dealer example, a prospective lead buyer may be given the option to ask a series of qualifying questions through the lead seller. For example, as part of the car purchase experience, the lead seller may ask certain qualifying questions on behalf of the prospective lead buyer. The questions may be, for example, “do you travel long distance often?” and/or “do you listen to music or news when you travel?” and/or “do you own a large music collection?” A particular lead buyer may specify that they would only buy the sales lead if one or more of the qualifying questions (and/or if a specific qualifying question) is satisfactorily answered. The lead buyer and/or the lead seller may establish different pricing levels for different leads quality. For example, a customer who answered affirmatively to all three qualifying questions (i.e., a “hot” prospect) may command a different price as a sales lead than a customer who answered affirmatively on only one or two questions (i.e., a “lukewarm” lead). As another example, a customer who answers affirmatively to a “key” question may command a higher price than one who fails the same “key” qualifying question.

In this manner, the process of qualifying leads becomes highly granular. In addition to the initial judgment regarding whether the transaction is complementary, the prospective lead buyer is allowed to use his judgment to craft qualifying questions to be posed by the lead seller. These questions tend to be questions that are, in the experience of the lead buyer, most likely to yield a productive sale. Thus, the expertise of the individual complementary goods/services providers are leveraged.

Lead buyers and lead sellers can also rate one another based on the quality of the leads provided, the feedback from customers, etc. Thus a lead seller who consistently provide high quality prospects may enjoy a better rating (and may enjoy higher bidding prices from prospective lead buyers) than a lead seller who consistent provide sales leads that do not lead to consummated sales for the actual lead buyers. A lead buyer who is judged by customers to have provided superior products/services may enjoy a better rating than a lead buyer who are judged by customers as poor providers.

These ratings may factor into the bidding price by the prospective lead buyers or may be used by the lead seller to determine whether to accept a bid. Another factor in bid pricing may pertain to whether the bid is for an exclusive referral or a non-exclusive referral. If the bid is for an exclusive referral, the winning actual lead buyer identity will be furnished to the customer as a referral exclusively. If the bid is for a non-exclusive referral, there may be multiple winning actual lead buyers and their identities will be provided to the customer in a non-exclusive manner. Exclusive bids tend to be higher than non-exclusive bids as lead sellers require a high exclusive bid to make up for the lost revenue opportunity from other non-exclusive bidders.

Another factor in bid pricing may pertain to whether there is a “success fee” associated with the bid. For example, a bid from a lead buyer may be low but may be associated with a “success fee,” which is payable by the lead buyer to the lead seller if the referral turns into an actual sale. In some cases, the presence of a success fee may make an otherwise low bid more attractive to the bid seller, particularly if the lead seller is confident that the customer is likely to purchase the goods/services offered by the complementary goods/service provider.

For service providers requiring the personal presence of a human service personnel, distance to the location where the service is to be rendered may also factor into the bid price. A prospective lead buyer may factor into the bid price for a particular lead seller (or customer) across town the cost of driving across town to service customers of that seller and may therefore provide a lower bid than the bids provided to a lead seller (or customer) that is located closer. In certain industries, geographical restrictions may preclude certain service providers from providing the service in another “territory” and distance may be employed by either the prospective lead buyer or the lead seller to determine whether to provide/accept a bid.

In an embodiment, the lead sellers have the option to accept or reject a lead based on price, rating, and/or other factors. For example, the automobile dealer lead seller may reject a stereo installer based on the fact that the stereo installer is located too far from the dealership and is thus too inconvenient for the customer to obtain follow-up service. As another example, the automobile dealer may reject bids from a particular stereo installer based on the fact that there have been numerous complaints from customers regarding that stereo installer's practice. As yet another example, the automobile dealer/lead seller may also reject bids from competitive dealerships who also happen to sell/install high-end stereo systems because the automobile dealer/lead seller does not want to risk losing future sales of automobiles to the same customer. By allowing the seller control over which bid to accept, the seller can maximize the bid price while minimizing the possibility of antagonizing the customer with bad referrals and/or losing the customer to the competition.

In an embodiment, prospective lead buyers who did not win the bids do not have to pay for the sales leads. Thus, unlike the Post Office example in which all contracting complementary product/service providers pay for the printing/advertising of the materials promoting the complementary goods/services, the cost is borne only by lead buyers who is most interested in utilizing the sales leads.

In embodiments of the invention, most or all of the aforementioned steps are computer-implemented to shorten the time required to identify approved complementary offerings from winning prospective lead buyers to enable to lead seller to present the referral information to the customer while the opportunity presents itself and/or to rapidly provide the sales leads information to the winning lead buyer.

Thus, in the automobile dealership example, the transaction between the customer and the automobile dealer service agent (which may be a sales person or the selling website) creates transaction data that is employed by software to generate a sales lead. Computer software then identifies an actual lead buyer from the list of subscribing/bidding prospective lead buyers and the referral information (such as the identity of the actual lead buyer(s) and/or their offerings) may be presented to the customer while the customer is still in the showroom or still conducting the original automobile car buying transaction on the website. In an embodiment, computer-generated scripts allow the qualifying questions from the actual lead buyers to be woven into the transaction so that the process of obtaining qualifying information for the complementary goods/service providers and the process of presenting referral information can occur in a seamless, conversationally natural manner.

It should be recognized that in some cases, it is not absolutely necessary to provide the identity information of the actual lead buyer to the customer. The sales lead cross-selling may involve, in an embodiment, providing the identity of the customer to the actual lead buyer and let the actual lead buyer perform his own sales/marketing effort. With respect to the automobile purchase example, the identity and/or product data of the high-end stereo suppliers/actual lead buyers may be provided to the customer by the automobile dealership/lead seller in an embodiment. In an alternative embodiment, the identify of the customer (and other relevant data) is provided to the high-end stereo suppliers/actual lead buyers in a temporally relevant manner to allow the high-end stereo suppliers/actual lead buyers to perform their own marketing to this customer on their own terms.

In another embodiment, a pre-computed time-delay is provided so that some time is allowed to pass before the referral information is provided. For example, a customer buying a baby crib may generate transaction data that would be relevant to a toy seller six months in the future, to a baby book seller two years into the future, to a private kindergarten four years into the future. Computer software implementing the invention would factor in the time delay and execute the bidding and/or referral in a temporally relevant manner. Since a transaction may generate multiple sales leads bidding opportunities into the future, revenue for the lead seller is maximized.

At the back-end, the sales leads data (e.g., customer identity, related transaction data, etc.) may be provided to the actual lead buyer through a variety of communication means including email, file exchanging, phone, fax, mailing, etc., Further, payment is settled for the sale of the sales leads and/or the presentation of the identity of the actual lead buyer to the customer. If a success fee is involved, payment may be settled for the successful sale of the complementary goods/services at a later date. If the sales leads cross-selling system is operated as a business independent of the lead sellers/lead buyers, the company operating the sales leads cross-selling system may collect the payment from the actual lead buyer(s) and forward the payment to the lead seller(s) after subtracting an appropriate fee for operating the sales leads cross-selling the service.

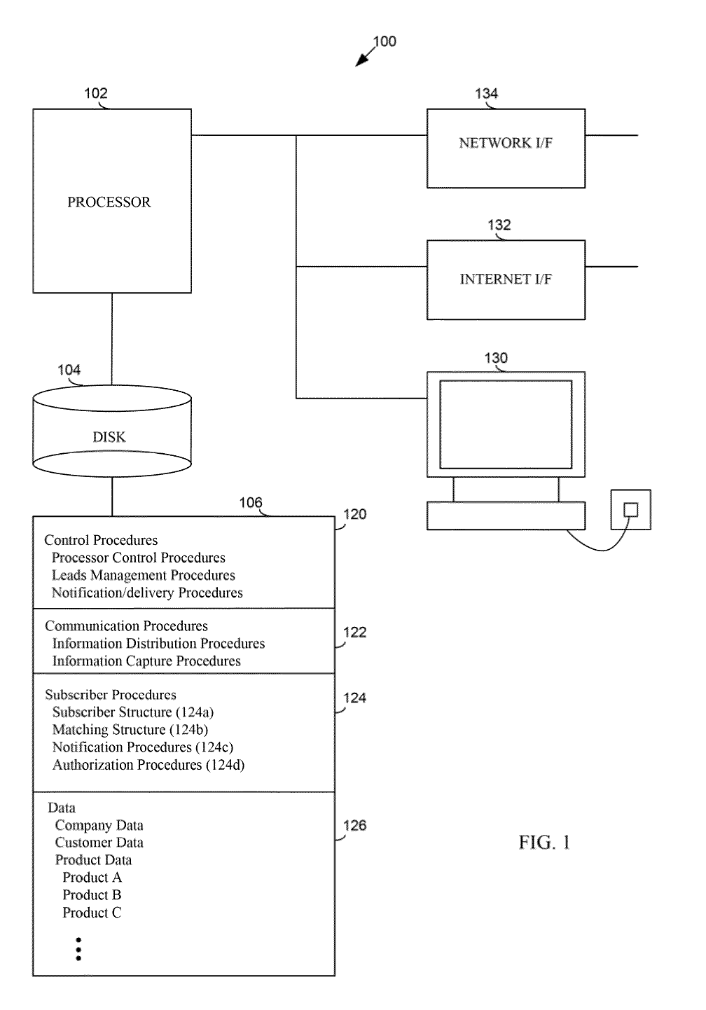

The features and advantages of the invention may be better understood with reference to the figures and discussions that follow. FIG. 1 illustrate a server environment 100, representing the computer system employed to implement the sales leads cross-selling service in accordance with an embodiment of the present invention. Server environment 100 includes a processor 102 and a storage device 104, for example, a disk drive. The storage device stores information 106 including control procedures and data for implementing the sales leads cross-selling service. The server 100 further includes interfaces 132, 134 to communication with other computers and networks as well as an administrative interface 130 for managing server environment 100.

Interfaces 132 and 134 are configured to communicate with lead sellers and prospective/actual lead buyers or in some cases, even the buyers themselves if the referral data pertaining to the complementary providers are to be sent to the customers directly. Through interfaces 132 and 134, the lead sellers and prospective/actual lead buyers can provide (via computers that are coupled to communicate with interfaces 132 and/or 134, for example) data pertaining to themselves, the products/services they offer, the transaction data pertaining to the transaction that generate the sales lead, the bidding data, any communication to facilitate the bidding and/or contract formation, acceptance data that forms a contractual agreement between a lead seller and one or more actual lead buyers, payment data, and/or the like. Interfaces 132 and 134 may also be coupled to communicate with other networks (e.g., fax, phones via computer-generated voices, short message services or SMS messages, instant messaging messages, etc.) to obtain and/or provide some or all of the aforementioned data. Preferably, the data is exchanged through the Internet, via a secure or unsecured communication arrangement, in an embodiment.

In an embodiment, disk 104 works cooperatively with on-board random-access-memory (RAM) to implement a variety of procedures and stores a variety of data. For example, the memory 126 is configured as a database to store information regarding company information, company's value proposition, products/services, etc. In an embodiment, the products/services data stored in the memory include a plurality of attributes that indicate, for example, the name, use, price, and other information. In an embodiment, the attributes include additional details, for example, when the product/service might be useful, under what conditions the product/service might be used, the name of the manufacturer or distributor, etc.

A subscriber structure 124a manages each lead seller/lead buyer that communicates with the server environment 100 over the internet interface 132 or network interface 134. The subscriber structure represents the interface software coupled with authorization procedures 124d that control access to the data and log the usage.

Depending on whether a particular company acts as a lead seller or a lead buyer, a matching structure 124b is configured to identify complementary goods and services, to perform the bidding and negotiation, to accept the bidding terms and/or reject unacceptable bids, etc. A notification procedure 124c is employed to communicate with the lead seller (if the company is acting as a lead buyer) or with the lead buyer (if the company is acting as a lead seller).

Procedures 122 and 120 represent control and communication procedures that are global to all companies. Thus, communication procedures include global information distribution procedures and information capture procedures designed to govern the flow of information between lead buyers and lead sellers (and optionally to/from customers). Control procedures 120 include process control procedures, lead management procedures, and notification/delivery procedures to manage the respective processes at a global level. FIG. 1 represents an example implementation and other implementations are possible given the description herein.

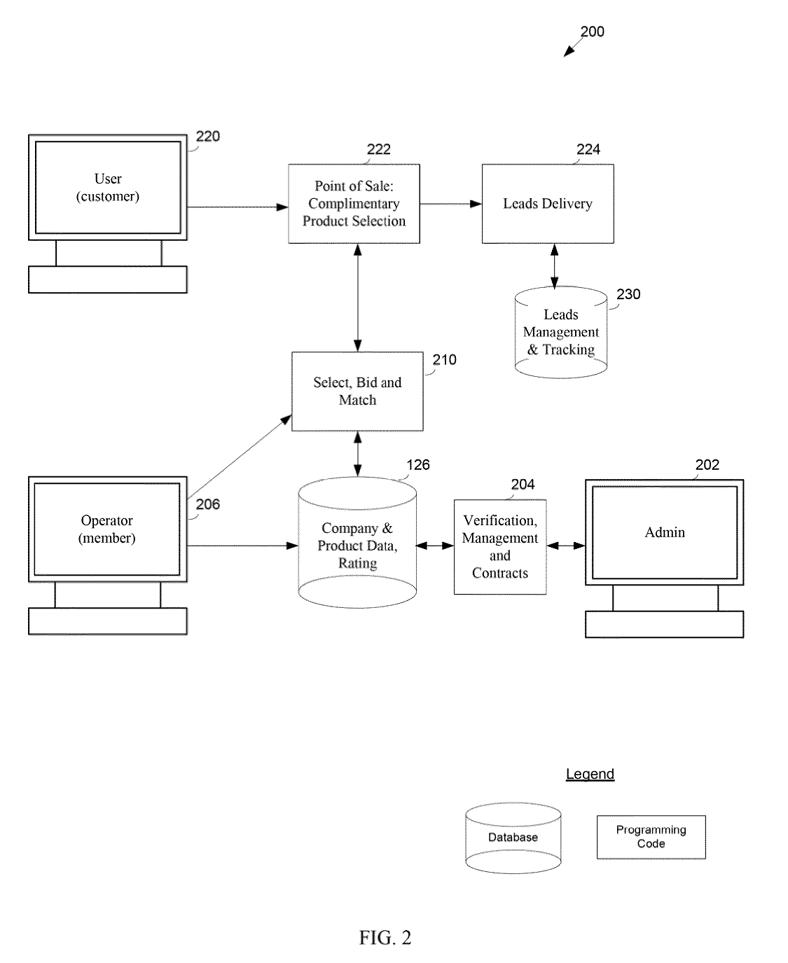

FIG. 2 shows, in accordance with an embodiment, various components of the sales leads cross-selling system. In FIG. 2, subscriber 206 represent lead sellers and lead buyers, while customer 220 represent a customer who is conducting a transaction with a lead seller (via a website in the example of FIG. 2). Subscribers 206 enter company and product data, preferred qualification questions to be posed, as well as ratings for past sale leads referrals, into a database 126. Table 1 shows some example profile and product data that may be entered.

TABLE 1

| Company | Profile | |
|---|---|---|
| Dish Planet | Dish Planet is an authorized dealer for | |
| | DISH Network and DIRECTV. We | |
| | specialize in satellite-based television | |
| | products/services to residential and | |
| | commercial end users. We also manage the | |
| | installation of all equipment needed to | |
| | utilize and view the satellite service. | |
| Subscription type | Buyer and Seller | |
| Category | Satellite TV entertainment | |
| Product 1 (Seller) | Product 1 Seller, Attributes | |
| DIRECTV Satellite TV | Pre-Qualification Questions: | |
| subscription | 1. | Did you ever subscribe to DIRECTV in |
| | | the past? (Reqd. No) |
| | 2. | Do you have a credit card? (Reqd. Yes) |
| | 3. | Do you live in an apartment (Reqd. No) |

| | |
|---|---|
| Product Value proposition | Lower your cable bills with all Digital |
| | programming starting at $30/mo, with Free |
| | HDTV receiver and Free Installation, |
| Delivery Options | Phone, email, database |
| Delivery times | M-F, 6AM-9PM PST, S-S; None |
| Maximum Leads Available | M-F, 300 per work day |
| Minimum $/lead | $5 |
| Geographic coverage | CA, OR, WA, AZ, TX, WI, IL, MI, MN |
| Payment method | Credit Card |

Referring back to FIG. 2, the identity of the subscriber, his access privilege, and other back-end functions (such as account management and contract data, payment, etc.) are performed by procedures 204. If needed, an administrative console 202 is employed to manage various aspects of database 126 and procedures 204.

At point of sale 222, a transaction occurs. The transaction generates transaction data, which may be employed in an embodiment as a filter to identify the complementary products/services. Based on the information provided by the transaction that occurs at the point of sale 222, complementary products/services providers may select and bid for sales leads(210). Example bid data for a fictitious potential lead buyer (“Joe's Electronics”) is shown in Table 2 below, in accordance with an embodiment of the present invention.

TABLE 2

| | |
|---|---|
| Company: Joe's Electronics | |
| Company Selected | Dish Planet |
| Product Selected | DIRECTV Satellite TV subscription |
| Max. Requested Leads/day | 50 |
| Period Leads requested | Sep. 30, 2005 to Oct. 01, 2005 |
| Days Leads requested | Monday, Thursday, Saturday |
| Daily Time Range for Leads | 9AM to 8PM PST |
| Requested | |
| Bid price per Lead | $5 |
| Delivery option | Phone, Ph# 800-333-3322 |
| Geographic coverage | CA |

Accepted bids form matches (210), which are then employed to determine to which lead buyer(s) the sales leads should be delivered(224). Leads are managed and tracked by procedures 230 to facilitate back-end settlement (e.g., payment for sales leads, ratings, etc.).

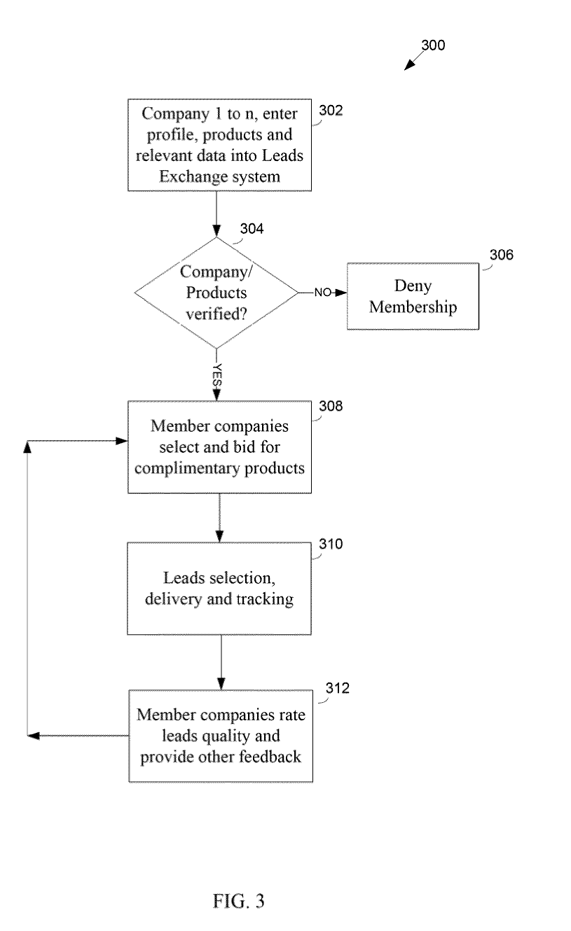

FIG. 3 shows, in accordance with an embodiment of the present invention, an example process flow 300 for implementing sales lead cross-selling. In step 302, the various lead seller and lead buyer companies enter their profiles, product and other relevant data. It should be recognized that a given company may act as a lead seller for some products/services and/or a lead buyer for other products/services. In step 304, an operator of the lead-exchange service may verify the entered data to ensure that the company/product data is accurate and can be verified to prevent fraud. If verification is not possible, membership may be denied (306).

If the profile/product data is verified (yes branch of step 304), prospective lead buyers may view the profile/product data from the lead sellers and bid for leads (308) if they deem there is a complementary fit. Bidding and subsequent acceptance/rejection/negotiation give rise to contractual obligations to deliver sales leads as well as to pay for sales leads (310). Once the sales leads are delivered, the member companies may rate one another based on contractual performance, lead quality, customer feedback, etc. (312). Back-end settlement may also occur as part of step 312. The process continues as lead seller companies generate sales leads and prospective lead buyers bid for leads.

As can be appreciated from the foregoing, embodiments of the invention facilitate an efficient and highly scalable system for exchanging sales lead data. Embodiments of the invention enable the lead seller companies to maximize the additional revenue from lead data by improving the lead quality (through the qualification questions and through temporally-relevant delivery of sales lead information and/or delivery of referral information to the customer) as well as by generating competitive bids from prospective lead buyers. Further, the lead seller is furnished a degree of control over the company or companies that would be referred to the customer (by, for example, deciding which bid to accept). The prospective lead buyers are furnished a degree of control over which leads to buy, how much to pay, and how the leads are qualified to lower the cost of lead acquisition as well as to improve the odds of a successful sale of another product/service.

In one or more embodiments of the invention, a phone lead exchange (PLE) portal is provided, along with methods for enabling lead sellers and lead buyers to complete and account for phone lead transactions. In a typical direct response phone sales environment, the caller acquisition cost (i.e., the cost to get a prospective human customer to call into a call center to initiate a purchase transaction) is typically quite high. For example, a typical caller acquisition cost for a consumer product advertised on television may be in the order of tens of dollars (e.g., it costs tens of dollars for every person calling into the call center of the seller). The caller acquisition cost for a product or service advertised on other media (such as newspaper, online or radio), may be less or more but tends to be quite expensive as well. Of the number of potential customers/callers who call into the seller's call center, some percentage of the callers will be converted into actual buyers of products or services. The remainder may, for example, decline after obtaining further information or may wish to defer making a decision on purchase.

Irrespective whether the prospective customer/caller consummates a transaction with the product/service seller, embodiments of the invention enable the seller to derive additional revenue from selling the phone leads to interested lead buyer(s). The lead buyer now has a new channel for inbound, qualified phone leads. In one or more embodiments, lead sellers and lead buyers register with the PLE portal to enable lead sellers and lead buyers to exchange phone leads in real time. If the prospective customer/caller does not want to be transferred to the lead buyer at that instance (in real time), they can opt to get a “call back” from the lead buyer.

As part of the registration process, a lead seller may provide information about his company, his location, his products/services, hours of operation, geographic and demographic data pertaining to his customers, etc. For example, hours of operation and/or geographic data may be used to filter through the list of bidding lead buyers first before filtering based on bid price is done in an embodiment. Lead sellers can decide to keep their sell campaigns open to every buyer and seller on the PLE portal or they can opt for a closed system, where they select the lead buyers that can view and bid on their leads. Lead sellers can in turn opt for automatic matching of buyer's campaigns by the PLE portal based on revenue maximization criteria (explained later) or can opt for manual matching of all buy campaigns. A lead seller can set up multiple campaigns to sell phone leads. Lead seller can also create user accounts on the PLE portal for their sales agents, and assign sales campaign to each sales agent if they choose to. The seller agents can then login individually into the PLE portal to interact with it.

In an embodiment, when a seller agent logs into the PLE portal, a logic module looks up which lead buyer gets the leads based on, for example, filters and/or highest bid, then displays appropriate lead buyer's pre-qualification question. As discussed herein the lead buyer's pre-qualification is employed by the sales agent of the lead seller to qualify the customer/caller. If PLE portal integration to other databases, such as CRM databases, then a sales agent may click on the “transfer” button or a similar button on screen or enter a keystroke sequence to transfer the call to the lead buyer if the caller/customer is deemed qualified based on the pre-qualification question provided by the lead buyer. If there is no integration for automatic call transfer, a manual external call transfer from the lead seller to the lead buyer may be made in a conventional manner to allow the lead buyer to interact with the caller/customer. If the caller/customer wishes or if the lead buyer is busy, the system can set up a call back time to allow the lead buyer to interact with the caller/customer at a later time.

Likewise, a lead buyer may provide information about his company, his location, his complementary products/services, hours of operation, desired geographic and demographic data pertaining to their leads, maximum budget, etc. The lead buyer may also furnish a telephone number at which the lead buyer wishes to receive the transferred call (i.e., the call from the consumer/caller after the consumer/caller has been transferred by the lead seller to the lead buyer), including the concurrent call capacity for that number. A lead buyer may also provide one or more pre-qualification questions to have the seller's call center personnel ask the consumer/caller prior to transferring the call to the lead buyer. A lead buyer can setup multiple campaigns to buy leads, in one or more embodiments.

The concurrent call capacity insures that the PLE portal only sends as many phone leads as the buyer's call center can handle. In one or more embodiments, the PLE portal transfers calls to the lead buyer until the maximum number of concurrent calls is reached. Once this happens, the PLE portal can, depending on configuration, either transfer calls to another lead buyer or sets up call backs to the lead buyer that is temporarily unable to handle additional concurrent calls.

In turn, the lead seller is furnished with one or more intermediate phone numbers for every campaign they create. An intermediate phone number is a phone number assigned by the PLE portal for the purpose of facilitating and tracking the buying/selling of phone leads and will be explained later herein. The information pertaining to lead sellers and lead buyers is then saved in a portal database.

Table 3 illustrates some example data that may be obtained by lead sellers and lead buyers during set up.

TABLE 3

| | Lead Seller | Lead Buyer |
|---|---|---|
| | campaign | campaign |
| Product/service description | Yes | n/a |
| Open or Closed system | Yes | Yes |
| Manual or Automatic Matching | Yes | n/a |
| CRM/CTI selection for seamless integration | Yes | n/a |
| Times of Operation | Yes | Yes |
| Concurrent call capacity | No | Yes |
| Budget per day, per campaign | Yes | Yes |
| Geographic info (area codes) | Yes | Yes |
| Pre-qualification question | n/a | Yes |
| Provide phone number (to receive leads) | n/a | Yes |
| Minimum floor bid, $/lead | Yes | n/a |

As part of the bidding process, the lead buyer may search the database for suitable lead sellers based on the information provided by the lead sellers during registration. For example, a goods/service supplier acting as a lead buyer may search for complimentary or certain types of goods/service suppliers. Once the suitable lead sellers are ascertained, a lead buyer can submit a bid for phone leads to the suitable lead sellers. In one or more embodiments, lead seller enters two bids, one for live phone leads and another for getting potential customer/caller's phone number for a call back. It is expected that more than one lead buyer will bid for a lead sellers leads.

In one or more embodiments, whenever a lead buyer bids on a lead seller and the bid is above the buyer's minimum threshold (S/lead), then the bid is “linked” to that lead seller's campaign. A lead buyer has the option to withdraw a bid at anytime. Lead buyers can also change their bid (S/lead) at anytime to become the highest bidder. In one or more embodiments, to determine who has the winning bid at any give time, the PLE portal first applies filters like geographic coverage, hours of operation, concurrent calls and budget/day. Then among all the lead buyers that satisfy the filters, the system checks who has the highest bid (S/lead) and awards that lead to that lead buyer. If no lead buyer makes the cut, then system checks to see who is the highest bidder for call backs and awards the lead to that lead buyer. The lead seller sales agent then records the customer's phone number as a call back lead. The PLE portal always performs this check for every prospective caller, in one or more embodiments.

By checking for concurrent calls, the PLE system ensures that it only forwards the number of leads that a lead buyer system can handle at a given time. Therefore there are no instances of long wait times or dropped calls. The PLE portal solves a long standing problem in the direct response marketing environment in that it can now intelligently control lead volume going to any lead buyer. For example, when advertising on TV, no one can control how many callers can call the advertisers phone number at any given time. If the advertiser gets more calls than it can handle at their sales center, it looses the excess calls (dropped calls, busy signal).

The geographic filter (phone area codes) allows regional companies, like small businesses, to participate in the PLE portal business model. The concept is simple; if I am a “seller” and have my business in San Jose, then my potential customers are people with area codes 650-, 408-, 415-, and 510- and if my business covers a bigger area, like the state of California, Arizona, Portland and Nevada, then I want potential customers/callers from those states only. A local or regional lead seller will also know his potential callers, based on where they do business and advertise.

To get geographic filter (phone area codes) into play, lead buyers and lead sellers first need to enter these geographic filters into their buy/sell campaigns. Then when campaigns go live, PLE portal identifies or reads the potential caller's geographic location and passes it thru the system's geographic filter test to see which lead buyer qualifies for that caller. With CTI integration, this checking is done seamlessly. Without CTI integration, the lead buyer agent would need to manually enter and submit area code before PLE portal returns the appropriate lead buyer pre-qualification question. Of course any other characteristics of the customer/caller may also be employed as a filtering criterion.

Suppose a satellite dish TV system seller has registered as a lead seller and has furnished information required of a lead seller with the PLE portal. Based on the data entered by the lead sellers, lead buyers may search the database of lead sellers to find lead sellers whose products/services would likely be complementary to those offered by the lead buyers. In this case, suppose a high-end stereo supplier searches through the database of lead sellers and identifies a particular satellite dish TV system seller as the suitable lead selling entity having the desired complementary products/services and/or the desired consumer/caller demographics and/or geography. The lead buyer/high-end stereo supplier may then enter a bid to purchase phone leads from the lead seller/satellite dish TV system seller.

If the lead buyer is a winner (due to being accepted by the lead seller and/or due to being deemed to have offered the highest price and/or due to having met the filters like some minimum price threshold, geographic coverage, hours of operation, concurrent call capacity for example), the lead buyer's pre-qualification question (e.g., “would you like to receive a 10% discount on high-end stereo systems today?”) is used by the lead seller/satellite dish TV system seller to pre-qualify the consumer/caller prior to transferring the sales call from the lead seller/satellite dish TV system seller to the lead buyer/high end stereo supplier via the intermediate phone number. In one or more embodiments, a computer script is provided to the lead seller/satellite dish TV system seller to facilitate integration with the lead seller's call center or CRM software.

When a potential consumer/caller calls into the call center associated with the satellite dish TV system seller for the purpose of potentially purchasing a satellite dish TV system, the call center agent may obtain the name, address, and phone number of the customer/caller in the process of attempting to sell a satellite dish TV system to the consumer/caller. At the end of the primary transaction between the lead seller/satellite dish TV system sales agent and the consumer/caller, the lead buyer's qualification question is furnished to the sales agent in one or more embodiments. The furnishing may be achieved by a computer-implemented script integrated with the call center software or CRM software of the lead seller/satellite dish TV system seller, for example. The sales agent then poses the qualification question. If the answer to the qualification question is satisfactory, the call is transferred to the intermediate phone number provided to the lead seller. If the potential consumer/caller does not want to be transferred at that instance, they are given the option for getting a call back from the lead buyer. If they agree, their name (optional) and phone number (mandatory) is recorded by the lead seller. The phone number also provides the location or time zone of the caller. If the lead seller's CTI is integrated to the PLE portal, then the lead seller does not even have to enter the phone number manually as it's already captured by the CTI system and populated into the PLE system.

A telephone soft switch then connects the incoming call received at the intermediate phone number from the call center of the lead seller/satellite dish TV system seller with the outgoing call from the intermediate phone number to the lead buyer/high-end stereo supplier phone number (which was furnished by the lead buyer during registration). The PLE portal knows which lead seller's phone number is associated with the intermediate phone number because the PLE portal itself assigns the intermediate phone number to the lead seller. The PLE portal also knows which lead buyer is the winning bidder for that lead seller campaign and can determine the seller number to forward the call to. It should be noted that a lead seller may wish to have different intermediate phone numbers to associate with different campaigns, different products, different services, etc. Alternatively or additionally, it should also be noted that this phone mapping could be done in the opposite manner, by mapping the lead buyer's phone number to an intermediate PLE portal assigned phone number, to achieve the same result.

Once the incoming call into the PLE portal and the outgoing call from the PLE portal to the lead buyer/high-end stereo supplier are connected, the consumer/caller is effectively transferred. From that point on, call progress is monitored. Since all calls related to a particular campaign are funneled through one intermediate phone number or a set of intermediate phone numbers of the PLE portal, it is possible to track how many calls were transferred from a lead seller to a lead buyer. In one or more embodiments, if the transferred call lasts for a duration longer than some predefined threshold value, a successful referral is deemed to have been made between the lead seller and the lead buyer. Conversely, if the consumer/caller hangs up immediately or shortly after being transferred, it may be surmised that the consumer/caller was not very interested in the offering by the lead buyer/high-end stereo supplier. In some cases, such discrimination allows the lead buyer to negotiate for different tiered pricings for transferred calls (e.g., transferred calls that are deemed to be unsuccessful may be paid at a lower rate than transferred calls that are deemed to be successful).

As can be appreciated from the foregoing, embodiments of the invention enable the tracking of the transferred calls, down to the number of calls transferred, the identity of the lead seller, the identity of the lead buyer, and the duration of the call, all without having to query call data from either the lead seller or lead buyer. Such tracking is especially helpful during settlement time, i.e., when the lead buyer is invoiced for the transferred calls. Payment from the lead buyer may be forwarded to the lead seller with a portion retained by the operator of the PLE portal as “commission.”

The PLE portal also does not allow a lead buyer to sell the same lead back to the lead seller i.e. in letting the lead become circular. This happens when a lead seller also has a buy campaign going on and a lead buyer also has a Sell campaign going on and both the pairs are linked to each other. The PLE system generates a call detail record (CDR) immediately upon call setup. A part of the CDR would be the potential caller/customer's info. When accepting a new call system will check the CDR database to see if a call is already going on for that calling party and either reject it or flag it.

In one or more embodiments, if the consumer/caller declines the offering of the lead buyer based on the qualifying question (e.g., decline the offer to receive 10% discount on high-end stereo equipment), the computer script may include a question asking the consumer/caller for permission to call back at a time more convenient to the consumer/caller and optionally at a number specified by the consumer/caller. If the consumer/caller consents to a later call, the sales agent for the lead seller/satellite TV system supplier may set up an event with the PLE portal (via an integrated script in the CRM software or call center software, for example). The lead buyer can then call the consumer/caller at a later time. Alternatively, the call back can be automated, where the event wakes up at the specified time and completes the call from the lead buyer/high-end stereo supplier with the consumer/caller at the phone number specified by the consumer/caller. In one or more embodiments, the end-to-end call between the lead buyer/high-end stereo supplier and the consumer/caller may be connected via the PLE's soft switch. In one or more embodiments, the end-to-end call between the lead buyer/high-end stereo supplier and the consumer/caller may be connected via the PLE's soft switch via the intermediate number.

As can be appreciated from the foregoing, embodiments of the invention enable the exchange of sale leads in real time for the direct response phone sales environment. Sellers and buyers previously unknown to one another may register to exchange phone leads. Minimal changes need to be made to the seller's IT infrastructure in order to facilitate phone leads exchange. Further, the user of the PTE's phone switching system and/or the use of the assigned intermediate phone number facilitate tracking and phone transferring without requiring much, if any, change to the telephony infrastructure of either the lead buyer or the lead seller.

While this invention has been described in terms of several embodiments, there are alterations, permutations, and equivalents, which fall within the scope of this invention. For example, while reference is made to a server including a database, the database/code can also reside on a different server and be accessed over a network. Further, the mechanisms employed to present data, obtain data, accept bids, etc., may be implemented by a variety of techniques, including different pages on a web browser. These different pages for performing these different functions on the computing/telecommunication devices of the lead seller and lead buyers may be understood to represent different structures or means to accomplish the underlying tasks. Likewise, different procedures and code sections may be understood to represent different structures or means to accomplish the underlying tasks when executed at the computer arrangement that implements the sales leads exchange system.

Also, while the preferred network is the Internet, any communication network can be used in the invention. Also, while reference is made to sales leads, suspects, prospects, complementary products, services and related information, these terms are considered to be broadly defined to include customer attributes, product/service attributes and other characteristics to support a robust implementation of the invention. Thus the example of the figures refer only to a specific example embodiment and should not be construed as limiting.

It should also be noted that there are many alternative ways of implementing the methods and apparatuses of the present invention. It is therefore intended that the following appended claims be interpreted as including all such alterations, permutations, and equivalents as fall within the true spirit and scope of the present invention.

What is claimed is:

1. A computer-implemented method for managing a phone lead transaction between a lead seller and a lead buyer as part of a first transaction between said lead seller and a consumer, comprising:
displaying a pre-qualification question associated with said lead buyer on a display screen employed by an agent associated with said lead seller to conduct said first transaction to enable said agent to pose said pre-qualification question to said buyer, said phone lead transaction relates to a transaction for at least one of a product or a service that is different from said first transaction;
if an answer to said pre-qualification question by said consumer satisfies predefined prequalification criteria, establishing a call between said consumer and said lead buyer; and
tracking said call for lead billing purposes, whereby said lead buyer is charged for a first rate for a phone lead associated with said phone lead transaction if said phone lead is deemed to have been furnished to said lead buyer.

2. The computer-implemented method of claim 1 wherein said agent represents a telephone sales agent.

3. The computer-implemented method of claim 1 wherein said call between said consumer and said lead buyer is established prior to said consumer terminating his call session that involves said first transaction.

4. The computer-implemented method of claim 1 wherein said call between said consumer and said lead buyer is established at a time designated by said consumer, said time designated by said buyer representing a time that is after said consumer terminates his call session that involves said first transaction.

5. The computer-implemented method of claim 1 wherein said lead buyer is selected from a plurality of buyers bidding for phone leads from said lead seller.

6. The computer-implemented method of claim 5 wherein said lead buyer is selected based on bidding price.

7. The computer-implemented method of claim 5 wherein said lead buyer is selected based on geography.

8. The computer-implemented method of claim 1 wherein said pre-qualification question is furnished in advance by said lead buyer.

9. The computer-implemented method of claim 1 wherein said call is established using an intermediate phone number associated with said lead buyer, said call being established indirectly between said lead buyer and said lead seller and configured to be monitored by a call tracking module to enable a call tracking module to monitor said call

10. The computer-implemented method of claim 1 wherein said lead buyer is charged for said phone lead only if a time duration of said call exceeds a predefined time duration.

11. The computer-implemented method of claim 1 wherein said call is established prior to said consumer terminating his call session that involves said first transaction if a concurrent call handling capability of said lead buyer is not exceeded, and if said concurrent call handling capability of sad lead buyer is exceeded, performing one of designating a time with said consumer for establishing a subsequent call between said consumer and said lead buyer and establishing another call between said consumer and another lead buyer that is an alternate to said lead buyer.

12. The computer-implemented method of claim 11 wherein said another lead buyer represents a bidding lead buyer that has submitted a bid for phone leads from said lead seller.

13. The computer-implemented method of claim 1 wherein said lead buyer is selected using filter criteria that includes a factor other than maximum bid amount.

14. Computer-readable code for managing phone lead transactions between a plurality of lead sellers and a plurality of first lead buyers, comprising:
computer readable code for enabling a first lead buyer of said plurality of first lead buyers to bid for phone leads from a first lead seller of said plurality of lead sellers;
computer readable code for selecting said first lead buyer as a winning bidder for said phone leads from said first lead seller based on predefined bidding criteria;
computer readable code for connecting a call between a consumer and said first lead buyer if an answer by said consumer to a prequalification question asked during a first transaction between said first lead seller and said consumer satisfies predefined prequalification criteria, said prequalification question being associated with said first lead buyer and asked by an agent associated with said first lead seller; and
computer readable code for tracking said call for lead billing purposes, whereby said lead buyer is charged for a first rate for a phone lead associated with said phone lead transaction if said phone lead is deemed to have been furnished to said lead buyer.

15. The computer-readable code of claim 14 wherein said agent represents a telephone sales agent.

16. The computer-readable code of claim 14 wherein said call between said consumer and said first lead buyer is established prior to said consumer terminating his call session that involves said first transaction.

17. The computer-readable code of claim 14 wherein said call between said consumer and said first lead buyer is established at a time designated by said consumer, said time designated by said buyer representing a time that is after said consumer terminates his call session that involves said first transaction.

18. The computer-readable code of claim 14 wherein said first lead buyer is selected from a plurality of buyers bidding for said phone leads from said first lead seller.

19. The computer-readable code of claim 14 wherein said first lead buyer is selected based on bidding price.

20. The computer-readable code of claim 14 wherein said first lead buyer is selected based on geography.

21. The computer-readable code of claim 14 wherein said pre-qualification question is furnished in advance by said first lead buyer.

22. The computer-readable code of claim 14 wherein said call is established using an intermediate phone number associated with said lead buyer, said call being established indirectly between said lead buyer and said lead seller and configured to be monitored by a call tracking module to enable a call tracking module to monitor said call

23. The computer-readable code of claim 14 wherein said lead buyer is charged for said phone lead only if a time duration of said call exceeds a predefined time duration.

24. The computer-readable code of claim 14 wherein said call is established prior to said consumer terminating his call session that involves said first transaction if a concurrent call handling capability of said lead buyer is not exceeded, and if said concurrent call handling capability of sad lead buyer is exceeded, performing one of designating a time with said consumer for establishing a subsequent call between said consumer and said lead buyer and establishing another call between said consumer and another lead buyer that is an alternate to said lead buyer.

25. The computer-readable code of claim 24 wherein said another lead buyer represents a bidding lead buyer that has submitted a bid for phone leads from said lead seller.

26. The computer-readable code of claim 14 wherein said lead buyer is selected using filter criteria that includes a factor other than maximum bid amount.

27. A computer-implemented method for managing a phone lead transaction between a lead seller and a lead buyer as part of a first transaction between said lead seller and a consumer, comprising:
conducting at least a portion of said first transaction;
displaying a pre-qualification question associated with said lead buyer on a display screen employed by an agent associated with said lead seller to conduct said first transaction to enable said agent to pose said pre-qualification question to said buyer, said phone lead transaction relates to a transaction for at least one of a product or a service that is different front said first transaction;
if an answer to said pre-qualification question by said consumer satisfies predefined prequalification criteria, sending a first message, said first message causing a call to be established between said lead buyer and said lead buyer.

28. The computer-implemented method of claim 27 wherein said agent represents a telephone sales agent.

29. The computer-implemented method of claim 27 wherein said call between said consumer and said lead buyer is established prior to said consumer terminating his call session that involves said first transaction.

30. The computer-implemented method of claim 27 wherein said call between said consumer and said lead buyer is established at a time designated by said consumer, said time designated by said buyer representing a time that is after said consumer terminates his call session that involves said first transaction.

31. The computer-implemented method of claim 27 wherein said call is established using an intermediate phone number associated with said lead buyer, said call being established indirectly between said lead buyer and said lead seller and configured to be monitored by a call tracking module to enable a call tracking module to monitor said call.
